(19) United States
(12) Patent Application Publication
(10) Pub. No.: US 2011/0206920 A1
(43) Pub. Date: Aug. 25, 2011

(54) STRUCTURE REINFORCEMENT WRAP

(76) Inventor: Mohammad Reza Ehsani, Tucson, AZ (US)

(21) Appl. No.: 13/077,854

(22) Filed: Mar. 31, 2011

Related U.S. Application Data
(63) Continuation-in-part of application No. 12/233,849, filed on Sep. 19, 2008.
Application No. 12/233,849 is a continuation-in-part of application No. 12/589,229, filed on Oct. 19, 2009.
(60) Provisional application No. 61/395,073, filed on May 10, 2010.

(51) Int. Cl. B32B 3/26; B23P 17/04

(52) U.S. Cl. 428/304.4; 29/428

(57) ABSTRACT

A method and an article of manufacture are disclosed for reinforcing various structures, such as pipes, ducts, vessels, tanks, silos, chimneys, and the like, constructed from various materials including steel, concrete, masonry, wood, plastics, and the like. Some of the various structures may be used to transport water, gas, oil, and the like. Multiple layers of various material sheets, each sheet having substantially the same or different properties, may be wrapped around or be attached to the inside of a structure to be reinforced. The multiple layers together constitute a structure reinforcement wrap (SRW) and in an embodiment it may include a honeycomb layer surrounded by other reinforcement layers to reinforce the structure against external and internal loads, such as weight, impact load, blast load, internal pressure, ballistic load, and the like.

### CROSS-REFERENCE(S) TO RELATED APPLICATION(S)

This application is a continuation-in-part of U.S. application Ser. No. 12/233,849, filed on Sep. 19, 2008, and U.S. application Ser. No. 12/589,229, filed on Oct. 14, 2009, and claims the benefit of the filing date of the U.S. Provisional Patent Application 61/395,073, filed on May 10, 2010, the disclosure of which are hereby expressly incorporated by reference in their entirety, and the filing date of the Provisional application is hereby claimed under 35 U.S.C. § 119(e).

### TECHNICAL FIELD

This application relates generally to construction. More specifically, this application relates to a method and apparatus for reinforcing structures with a structure reinforcement wrap (hereinafter, “SRW”).

### BRIEF DESCRIPTION OF THE DRAWINGS

The drawings, when considered in connection with the following description, are presented for the purpose of facilitating an understanding of the subject matter sought to be protected.

FIGS. 1A-1D show example structures suitable to be reinforced with reinforcement wrap;

FIG. 2A shows an example external structure reinforcement using structure reinforcement wrap (SRW);

FIG. 2B shows an example internal structure reinforcement using SRW;

FIG. 3 shows an example internal structure reinforcement using SRW configured to support external forces;

FIGS. 4A-4C show example honeycomb and/or hollow layers usable as SRW components; and

FIG. 5 shows an example process of reinforcing a conduit structure using SRW.

### DETAILED DESCRIPTION

While the present disclosure is described with reference to several illustrative embodiments described herein, it should be clear that the present disclosure should not be limited to such embodiments. Therefore, the description of the embodiments provided herein is illustrative of the present disclosure and should not limit the scope of the disclosure as claimed. In addition, while the following description references using a honeycomb laminate and/or hollow-structure laminate surrounded by one or more layers of reinforcement material sheets to reinforce cylindrical structures, such as pipes, it will be appreciated that the disclosure may include fewer or more laminate sheets to reinforce other types of structures, such as walls, chambers, columns, and the like.

Briefly described, a method and an article of manufacture are disclosed for reinforcing various structures, such as pipes, ducts, vessels, tanks, silos, and the like, constructed from various materials including, but not limited to steel, concrete, masonry, wood, plastics, and the like. Some of the various structures may be used to transport water, gas, oil, and the like, while other such various structures may be used as storage, human-occupied buildings, computer and equipment facilities, and the like. Multiple layers of various material sheets, each sheet having substantially the same or different properties, may be wrapped around or otherwise attached to a surface of a structure to be reinforced. The multiple layers together constitute a structure reinforcement wrap (SRW) and may include at least a honeycomb layer surrounded by other reinforcement layers to reinforce the structure against external and internal loads. Such loads include weight, impact load, blast load, internal pressure, ballistic load, and the like. In various embodiments, SRW includes multiple honeycomb layers and multiple reinforcement sheets layered in various configurations and orders.

Structural repair can be expensive, cumbersome, and time consuming. Structures can get damaged due to a variety of factors, such as earthquakes, overloading, weight of traffic, wear and tear, corrosion, explosions, internal fluid or gas pressure, and the like. Prevention is generally more cost-effective than repairs. As such, it is generally easier and more cost-effective to strengthen a structure that may be exposed to damaging forces and loads, than waiting to repair such eventual damages after they occur or to replace the structure with a new one. Intentional damage inflicted upon infrastructure, by terrorism or vandalism, is another way that structural damage may result. For example, recently, there has been growing interest to strengthen the above-mentioned structures for blast loading, such as terrorist attacks, which may seek to blow up a gas or oil pipeline by placing a bomb adjacent to the pipeline and detonating it. In addition to prevention, if damage does occur to a structure, a cost-effective and speedy method of repair is clearly desirable.

One of the problems with existing pipes and culverts, such as corrugated metal pipes placed in infrastructure like under roads, is that they are subject to corrosion that weakens these structures. Since these culverts and pipes may be buried in soil, it is more cost-effective and thus preferred to repair them without digging them out. Often, these culverts are subjected to traffic, soil, and backfill loads from above. Thus a repair material and method should not only provide protection against corrosion, but also provide additional strength for the culvert. This is often referred to as ring stiffness; thus the new repair material should enhance the ring stiffness of the culvert.

In many cases, the topside or crown portion of a buried pipe, such as a sewer pipe, may become deteriorated due to presence of H₂S (Hydrogen Sulfide) gases or other conditions leading to corrosion of reinforcing steel components (rebar) in the structures around or in the pipe. Usually, the invert or bottom portion of these pipes, which may be substantially always covered under water, thus preventing contact with H2S, does not get damaged. There are products currently on the market, such as a products by Ameron International known as T-Lock Lining™, Arrow-Lock® and T-Hab™ for new construction and repair of damaged topside of existing structures. However, these products generally have limited stiffness and because of their flexibility, they must be supported from below by an elaborate system of frames and/or formwork, as described in their respective commercial literature, adding to their cost, ineffectiveness, and difficulty of application.

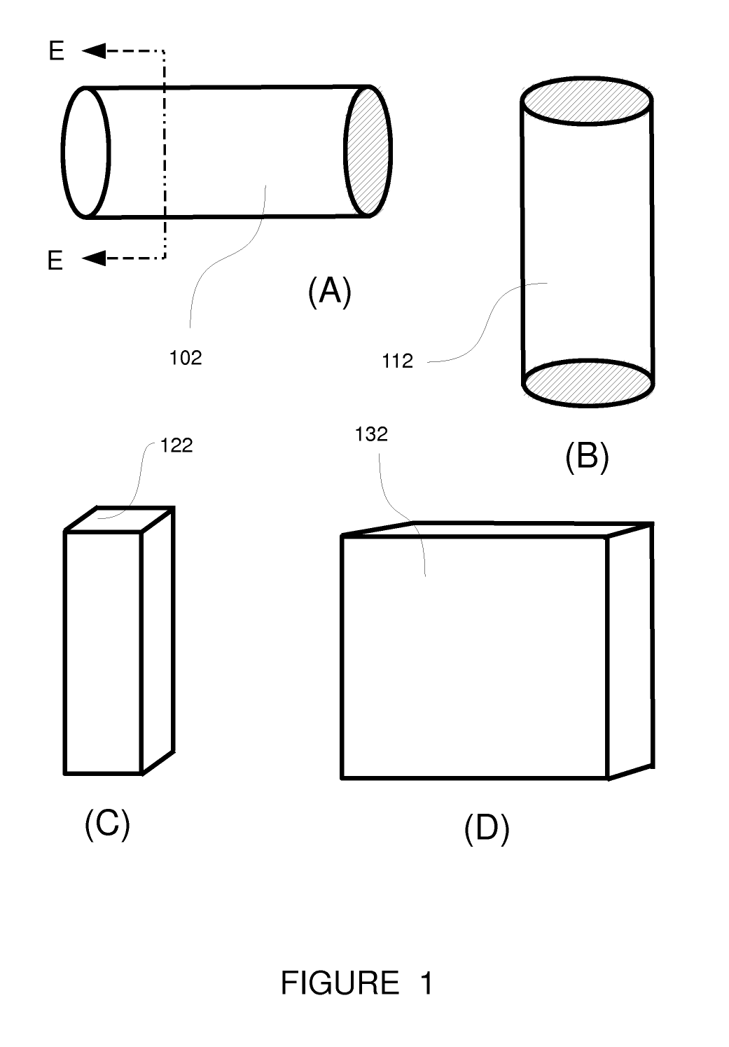

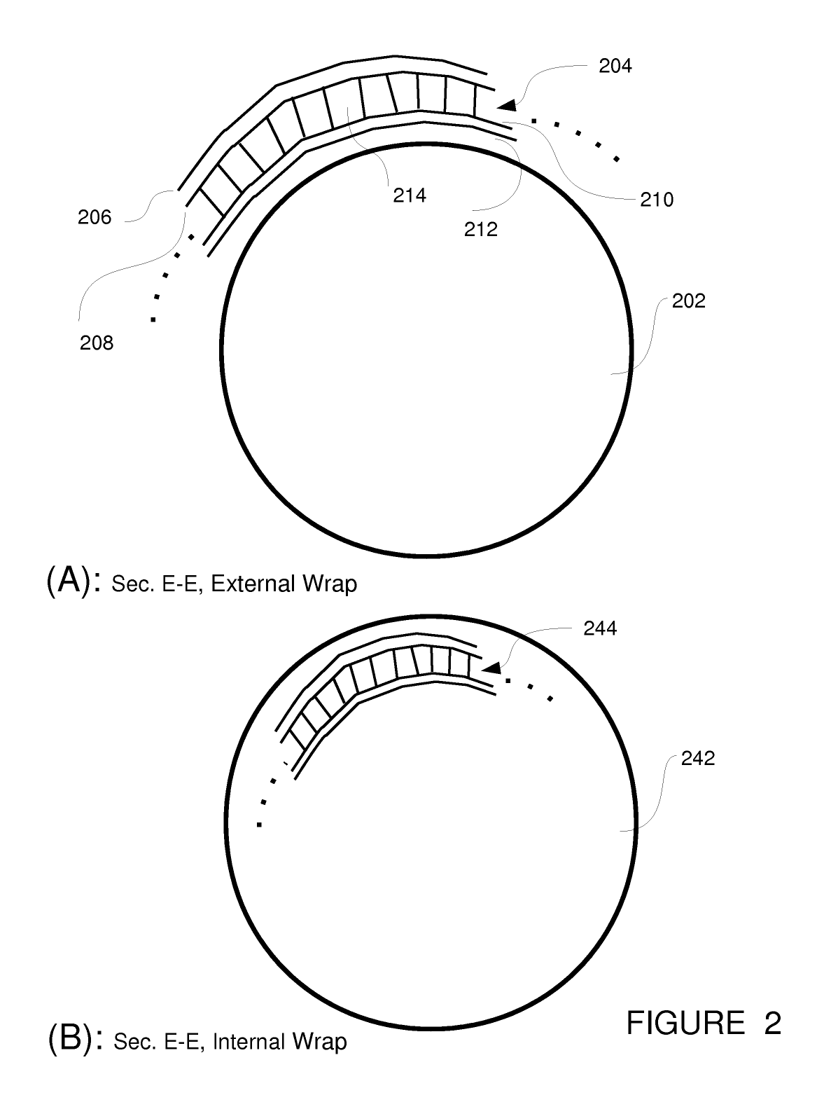

FIGS. 1A-1D show example structures suitable to be reinforced with reinforcement wrap. FIG. 1A shows a cylindrical pipe 102 in a horizontal position, while FIG. 1B shows cylindrical structure 112, such as a pipe, a column, a silo, a chimney, and the like. A section E-E of FIG. 1A is shown in greater detail in FIGS. 2A and 2B. FIGS. 1C and 1D show structures 122 and 132 with rectangular cross-sections, such as walls, chambers, and square columns. Any of these structures may be reinforced by the SRW laminates. Structures of relatively smaller sizes and accessible configurations, such as pipes and columns, may be wrapped with SRW laminate, while relatively larger and/or inaccessible structures such as walls, entire buildings, and the like may be augmented with SRW laminates on their surfaces, which may be exposed to potentially damaging loading, such as external wall surfaces. Those skilled in the art will appreciate that the structure to be reinforced may have any cross sectional shape in addition to round and rectangular, such as triangular, oval, polygonal, irregular, and the like.

FIG. 2A shows an example external conduit-structure reinforcement using structure reinforcement wrap. Section E-E of FIG. 1A is depicted in FIG. 2A. In various embodiments, structure 202 is wrapped, covered, or augmented with SRW laminate constructed from and including reinforcement layers 206, 208, 210, 212, and honeycomb layer 214. Honeycomb layer 214 may be laminated with at least two skin layers, for example, layers 208 and 210 to form a honeycomb or hollow laminate 204.

In various embodiments, structure 202, which may be a pipe, a culvert, a column, a wall, or other similar structure, is reinforced by multiple layers of reinforcement sheets including honeycomb or hollow-structure layer 214. Honeycomb layers are generally constructed of adjacent cells, each cell having walls that enclose the cells. Within each of the cells and surrounded by the cell walls, a hollow space is created to reduce the weight of the honeycomb or hollow-structure layer. The cell walls create a relatively thick sheet, the thickness of the sheet being substantially determined by the height of the cell walls, which sheet has substantially greater stiffness compared to a flat sheet of the same sheet material without such cells and cell walls.

In various embodiments, the reinforcement sheet is constructed from fiber-reinforced material, such as Fiber Reinforced Polymer (FRP) to give the sheets more resistance against various types of loading, such as blast loading. Those skilled in the art will appreciate that many types of reinforcement fibers may be used for reinforcement including polymer, fiberglass, metal, cotton, other natural fibers, and the like. The sheet materials may include fabrics made with fibers such as glass, carbon, Kevlar, Nomex, aluminum, and the like, some saturated with a polymer such as polyester, vinyl ester, or epoxy for added strength, wear resistance, and resilience. The fibers within a reinforcement sheet may be aligned in one direction, in cross directions, randomly oriented, or in curved sections to provide various mechanical properties, such as tearing tendency and differential tensile strength along different directions, among others.

The reinforcement layers may be laminated in the field using epoxy, various glues, or similar adhesives to create a thick laminate that will be stiffer than the sum of the individual reinforcement layers 206, 208, 210, 212 placed around structure 202. Different reinforcement layers may use sheets with fibers oriented in different directions, such as orthogonal directions, with respect to other sheets to further reinforce the SRW.

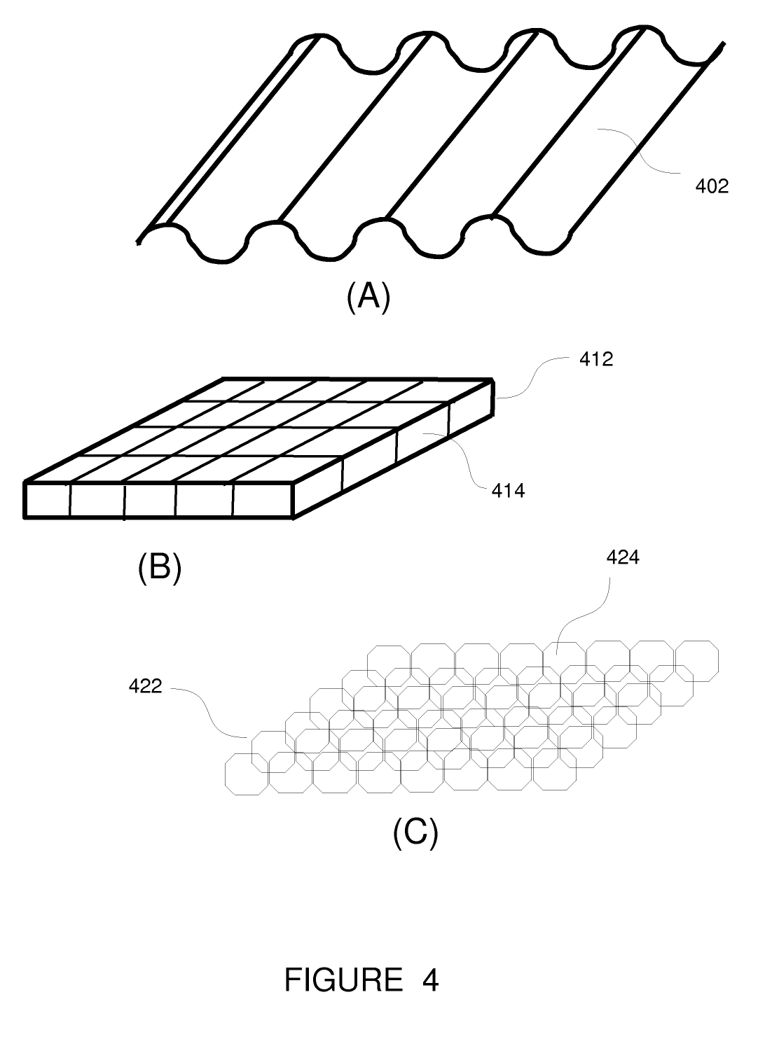

With continued reference to FIG. 2A, reinforcement sheets 206-214 are available from industrial sources and range in thickness from about 0.020 inches to a few inches depending on application. Those skilled in the art will appreciate that thinner or thicker sheets may be constructed and used as needed. Honeycomb or hollow structure itself is available in various geometrical cell shapes, as further described with respect to FIG. 4 below, and it provides cells that when sandwiched between a first and a second honeycomb skin layers made from thin reinforcement sheets results in a light-weight but stiff laminate sheet, like honeycomb laminate 204, with many applications, such as in the construction of the floor of commercial aircraft, fuselage of fighter planes, and watercraft. This honeycomb laminate layer structure provides additional strength to SRW and may serve as a structure to dissipate impact and blast energy, resulting in less damage to the reinforced structure 202. SRW may be wrapped continuously or in sections around the entire outside surface of structure 202 like a wide tape to create a closed, overlapping multi-layered shell enclosing structure 202.

In various embodiments, multiple honeycomb laminates 204 may be employed to further reinforce SRW. Various layers in the SRW may be glued to each other to form one integral laminate wrap. In some embodiments, each layer in the SRW may be made from a different or same type of reinforcement sheet to develop different costs, performances, and mechanical properties for the SRW. For example, the outer layers may be made from thicker and tougher reinforcement sheets while the inner layers (closer to the structure) may be made from thinner and more flexible sheets to save material and installation or construction costs. Other variations in sheet layers are possible, such as fiber types and orientations, sheet materials, sheet material properties like chemical resistance, heat resistance, gas and fluid impermeability, and the like. SRWs made with such variations in reinforcement layers will exhibit different mechanical and chemical properties suitable for different applications, costs levels, and considerations such as environmental and public safety considerations.

The multi-layer embodiments may be pre-glued and integrated prior to application to a structure or be integrated during the application to the structure.

In other various embodiments, some or all of the honeycomb or hollow-structure cells may be filled with one or more of a filler material, such as foam, concrete, polymer, and the like to displace the air within the cells and provide additional strength to the honeycomb or hollow-structure layer. The cell filling material may be injected or otherwise be placed within the cells after attaching the first honeycomb or hollow-structure skin layer, and then be covered and glued in place with the second skin layer. The skin layers themselves may be multi-layered in some embodiments.

In application, in various embodiments, the reinforcement layers are applied to the surface of the structure to be reinforced, one layer at a time using appropriate adhesives. Most honeycomb laminates are fairly stiff and cannot be wrapped around a structure as an integral prefabricated laminated layer. To facilitate the wrapping or attachment of the honeycomb layer to the structure, the honeycomb layer may be bonded to a first skin 210 in a manufacturing plant and after this assembly step, the honeycomb laminate is wrapped around the structure, and then second skin 206 is bonded to the open or free face of the honeycomb layer to complete the honeycomb laminate 204. Additional honeycomb layers or additional reinforcement layers may be applied to structure 202 to provide further strength for the structure. Alternatively, at least a first layer of thin laminate may be wrapped around or applied to the structure, then a layer of honeycomb may be glued or otherwise attached to the first layer of thin laminate, and finally at least a second layer of thin laminate sheet may be glued to the open face of the honeycomb. This process effectively constitutes the building of the honeycomb laminate in the field around the structure.

FIG. 2B shows an example internal structure reinforcement using SRW. The internal surface of structure 242 may be internally wrapped or covered with SRW 244 substantially in the same manner as described above with respect to FIG. 2A. The SRW layers used are also substantially as described above with respect to FIG. 2A. For various structures, particularly for pipes, the internal reinforcement may be used to resist internal pressures, such as fluid and gas pressures, and also to resist and/or repair corrosion and wear and tear. Additional layers of reinforcement sheets or honeycomb structures may be included in the SRW to provide the required strength and ring stiffness per engineering design requirements for external loads from soil, traffic, and the like Layers of SRW 244 may be applied continuously inside structure 242 to create a closed multi-layered reinforcement structure.

The SRW may be applied to various structures, such as pipes and culverts, using automated machinery, such as robotic apparatus to facilitate and automate the installation of the SRW inside or outside a pipe or other structure. Such robotic apparatus may be used to provide further economical advantage for all applications described herein.

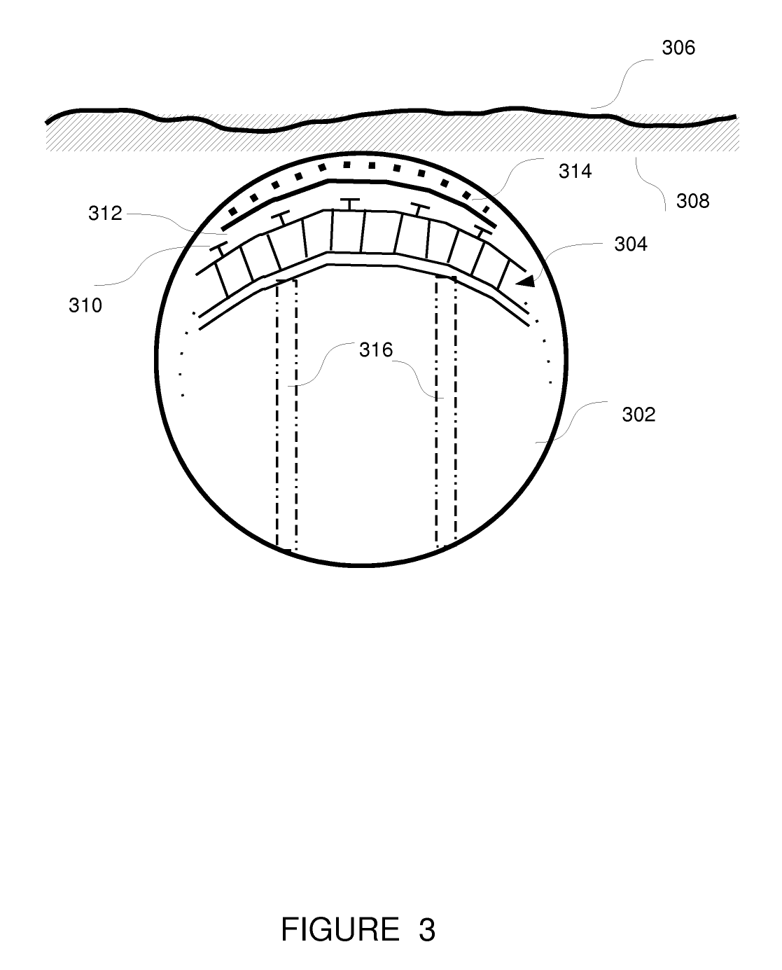

FIG. 3 shows an example internal structure reinforcement using SRW configured to support external forces. A structure, such as pipe 302 buried under ground surface 306, covered with soil 308 to a certain depth, is reinforced with SRW 304. T-section attachment components 310 may be used to further reinforce and stiffen SRW 304. T-section attachment components 310 are generally in the form of elongated beams (T-shape cross section shown in FIG. 3), having “T-shaped”, “I-shaped”, or other similar cross sectional shapes, which may be oriented along the length of the pipe, in hoop direction, diagonally around the pipe, or in a random fashion. In various embodiments, the top-side of the buried pipe or structure 302 may be further reinforced with concrete and rebar components, such as hoop rebar 312 and axial rebar 314. In certain circumstances temporary support columns 316 may be used during repair to support the weight of the concrete on the top-side of the structure before the concrete hardens and cures. The T-section components may be deployed in wet concrete, in a manner similar to rebars, to effectively attach and integrate the SRW with the concrete on top, to further reinforce and stiffen the combination.

When concrete is poured on the top-side of a buried structure, such as a pipe, to repair and/or to reinforce the structure, a stiff SRW may be used to support the weight of the fresh concrete or grout that is placed around it before the concrete sets and cures. SRW may fully or partially eliminate the elaborate framework that is often necessary with the products currently on the market used to support concrete repair and/or reinforcement applications. In one embodiment, SRW may be used in the upper arch portion of the pipe, such as the top 240 degrees or nearly two-thirds of the pipe's circumference. The ends of the SRW at the edges of the upper arch portion of the pipe may be supported along the length of the pipe. The upper part of SRW 304 may be attached to anchoring/locking devices, such as T-section attachment components 310. Concrete reinforcing components, such as rebar components may be placed in the space between the top of SRW and the top of the pipe as shown in FIG. 3. This area may then be filled with concrete or grout and the weight of the wet concrete can be supported by SRW along the length of the pipe. If additional support is needed while the concrete or grout is being cured, temporary shoring or support columns 316 may be used.

This process may be repeated in sections along the length of the pipe in an incremental manner until the entire pipe is reinforced. The edges of the SRW sections along the length of the pipe may be overlapped and sealed to ensure that the honeycomb laminate creates a virtually airtight ceiling for the pipe so that the H₂S gases or other gases, liquids, or corrosive elements are substantially prevented from reaching the newly placed concrete or grout. The joints between SRW sections along the length of the pipe may be joined shut using epoxy or thermal techniques.

The honeycomb laminate structure 304 itself may include a lower portion on the face away from the pipe's internal surface, which is made of a material including but not limited to vinyl ester reinforced with carbon or glass fibers that are highly resistant to gases and chemicals, which may be present in the pipe. This repair procedure allows the construction of a new ceiling for the upper portion of the pipe, which is very strong and corrosion resistant for a long service life and is able to carry high traffic and other loads from above.

In various other embodiments, the procedures described above with respect to FIG. 3, may be combined to build a new reinforced pipe inside an old or original pipe. This new pipe may be substantially concentric with the original pipe. The annular space between the old pipe and the new honeycomb pipe may be filled with grout or concrete and may also be reinforced with reinforcing material such as steel rebar components as described above. Such rehabilitated pipe will have an inner surface that is made with a corrosion resistant honeycomb laminate. it also provides significant strength for the old pipe by way of increased ring stiffness.

In yet other embodiments, the honeycomb structure and the protruding T-section attachment components 310 may be pressed against a layer of mastic, cement paste, other epoxy, or polymer material that has been applied onto the surface of the pipe. In addition to strengthening pipes, other cylindrical structures such as chimneys, tanks and silos may be strengthened with this technique. The described honeycomb or hollow structure, for example, when applied to the inside surface of an industrial or residential chimneys may provide a lining that is chemically and thermally resistant. Furthermore, such SRW-based internal lining will have very high ring stiffness and may prevent further erosion and deterioration of the interior surface of the chimney. The liner may also hold and push back the deteriorated interior surface of the chimney against the wall of the chimney and prevent any crumbling pieces from falling into the chimney and in general strengthens the structural integrity of chimneys.

In various embodiments, rectangular celled honeycomb structures may be advantageous during installation. In such rectangular celled honeycomb structures the short side of the cells' rectangles are more deformable and flexible in a perpendicular direction to the short side and stiffer along the short side. This directional flexibility allows easier and better fitting wrapping of the honeycomb laminate and/or the SRW around a small circumference or sharper structural bends.

In other various embodiments, PVC sheets that are available on the market and include attachment protrusions, such as T-section attachment components, may be used as one facial sheet of the aforementioned honeycomb and hollow structures. By bonding these sheets to the honeycomb that has a flat laminate sheet on the opposite face, a much stiffer system results that may eliminate the need for temporary support forms otherwise needed. Even if the support columns 316 are needed during the repair process, such T-section attachment components provide a gripping mechanism, which allow the SRW to become an integral part of the concrete that is placed above the SRW, so that the combination of the SRW and concrete on top become substantially stronger and stiffer even after the support columns are removed.

FIGS. 4A-4C show example honeycomb layers usable as SRW components. FIG. 4A shows an example corrugated structure 402 that in some embodiments may be used instead of the cell-based honeycomb layer described previously. The manufacturing and availability of such corrugated structures 402 may provide a cost advantage in some applications.

FIG. 4B shows an example square-celled honeycomb structure 414, where each cell is in the form of a square or rectangle rather than a hexagon or octagon as is typically implied by the term “honeycomb”.

Honeycomb structure may be constructed from many different materials similar to those listed and described above with respect to the reinforcement sheets, such as aluminum, PVC, Kevlar, Nomex, and the like.

FIG. 4C shows an example bubble-wrap structure 424 with closed bubble cells 422. In various embodiments, closed bubble cells 422 may be filled with filler material or pressurized air or gas. In various other embodiments, bubble cells 422 may be inflatable to various adjustable pressures. In such embodiments, bubble-wrap structure 424 may be wrapped around a structure in a deflated state, as described above as one of the layers in the SRW, and then be inflated to a desired pressure to obtain a predetermined stiffness for the SRW.

Those skilled in the art will appreciate that many other honeycomb type layers, hollow structures, or laminate structures are possible without departing from the spirit of the present disclosures. For example, the honeycomb cells may be constructed in any geometric form, such as rectangle, hexagon, and the like to serve the same purpose.

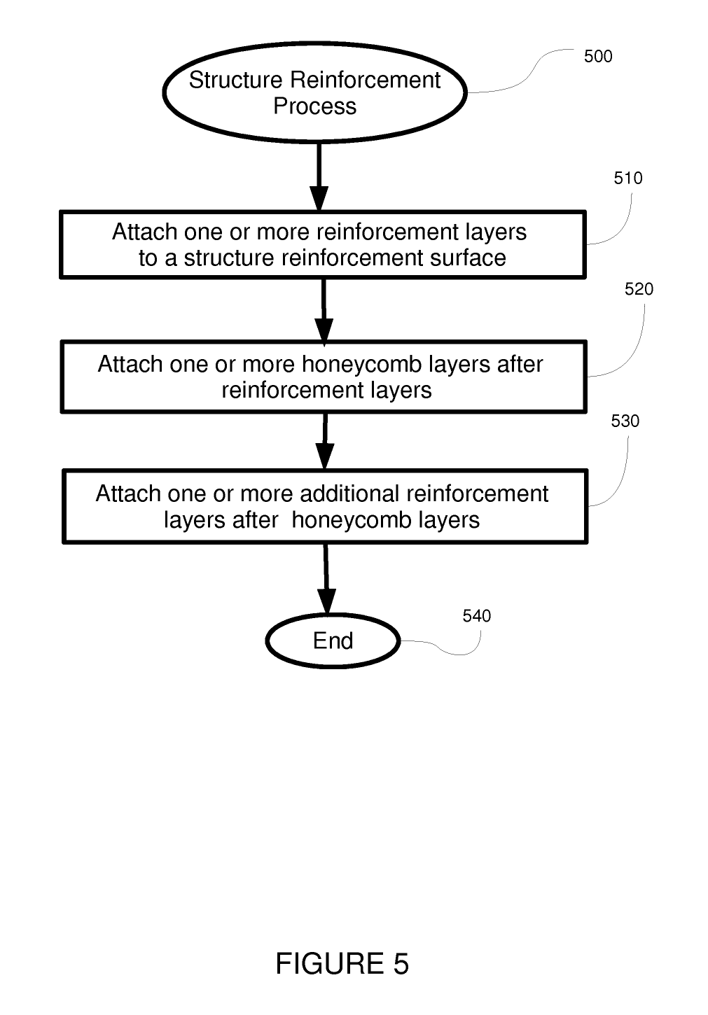

FIG. 5 shows an example process of reinforcing a structure using SRW. Process 500 proceeds to block 510 where one or more reinforcement layers are attached to a structure's reinforcement surface at which the structure is reinforced. As described above with respect to FIG. 2, different numbers and types of sheets may be used as the reinforcement layers in constructing the SRW. Such sheets may be attached to the reinforcement surface using adhesives, attachment components, fasteners, a combination thereof, and the like. The process proceeds to block 520.

At block 520, one or more honeycomb layers are attached over the reinforcement sheets using adhesives or other techniques. The honeycomb layer may be attached as a pre-integrated honeycomb laminate or be attached and laminated at the same time on application site in the field by attaching a first honeycomb skin, then the honeycomb layer, and then a second honeycomb skin. The process proceeds to block 530.

At block 530, additional reinforcement layers are attached on top of the laminated honeycomb layer. The above procedure may be repeated several times in different sequences to construct an SRW of the thickness, composition, and stiffness desired. Such SRW may include many layers of reinforcement sheets and many layers of honeycomb laminate structures, which may or may not be adjacent to each other. The process proceeds to block 540,

At block 540, the process terminates.

Changes can be made to the claimed invention in light of the above Detailed Description. While the above description details certain embodiments of the invention and describes the best mode contemplated, no matter how detailed the above appears in text, the claimed invention can be practiced in many ways. Details of the system may vary considerably in its implementation details, while still being encompassed by the claimed invention disclosed herein.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the claimed invention to the specific embodiments disclosed in the specification, unless the above Detailed Description section explicitly defines such terms. Accordingly, the actual scope of the claimed invention encompasses not only the disclosed embodiments, but also all equivalent ways of practicing or implementing the claimed invention.

The above specification, examples, and data provide a complete description of the manufacture and use of the composition of the invention. Since many embodiments of the invention can be made without departing from the spirit and scope of the invention, the invention resides in the claims hereinafter appended. It is further understood that this disclosure is not limited to the disclosed embodiments, but is intended to cover various arrangements included within the spirit and scope of the broadest interpretation so as to encompass all such modifications and equivalent arrangements.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method of reinforcing a structure, the method comprising:
attaching a first reinforcement sheet to a surface of a structure, a honeycomb or a hollow-structure layer, and a second reinforcement sheet to a surface of a structure.

2. The method of claim 1, wherein honeycomb or a hollow-structure layers are sandwiched between the reinforcement sheets in any combination.

3. The method of claim 1, where in the first reinforcement sheet, the honeycomb or a hollow-structure layer, and the second reinforcement sheet are attached to an inside, outside, or both surfaces of the structure in any combination and permutation.

4. The method of claim 1, wherein a first reinforcement sheet is attached to the inside or outside surface of the structure and a honeycomb or the hollow-structure layer is attached to the first reinforcement sheet and a second reinforcement sheet is attached to the honeycomb or the hollow-structure layer.

5. The method of claim 1, further comprising laminating the honeycomb or the hollow-structure layer with a first skin layer and a second skin layer.

6. The method of claim 1, further comprising filling some or all cells of the honeycomb or the hollow-structure layer with at least one filler material.

7. The method of claim 1, wherein the first, the second, or both reinforcement sheets include at least one kind of reinforcing fibers.

8. The method of claim 1, wherein the first reinforcement sheet, the honeycomb or the hollow-structure layer, and the second reinforcement sheet, in any combination and permutation, constitute a structure reinforcement wrap (SRW).

9. The method of claim 8, wherein the SRW is wrapped around the structure or attached to the inside surface of the structure, or both, to form a reinforcement shell.

10. A method of repairing a conduit structure, the method comprising:
attaching a first reinforcement layer and a hollow-structure layer and a second reinforcement layer to a surface of the conduit structure;

11. The method of claim 10, further comprising laminating the hollow-structure layer in a first and a second skin layer.

12. The method of claim 10, further comprising leaving a gap between the conduit structure and the conduit structure's adjacent layer, wherein the gap is configured to be filled with a reinforcement substance.

13. The method of claim 10, wherein attaching a hollow-structure layer to the first reinforcement layer comprises using an adhesive.

14. The method of claim 10, wherein the first reinforcement layer, the hollow-structure layer, and the second reinforcement layer constitute a structure reinforcement wrap (SRW), and wherein the SRW is at least partially prepared before attachment to the conduit structure or is attached to the conduit structure layer by layer.

15. The method of claim 14, wherein one or multiple first, second, and hollow-structure layers are attached to an inside, outside, or both surfaces of the conduit structure in any combination and permutation.

16. The method of claim 14, wherein the SRW is used to seal a portion of the conduit structure against liquids and gases.

17. A Structure Reinforcement Wrap (SRW) configured to reinforce a structure, the SRW comprising:
a first reinforcement sheet;
a hollow-structure layer; and
a second reinforcement sheet, wherein the first reinforcement sheet, the hollow-structure layer, and the second reinforcement sheet are attached to a surface of a structure.

18. The SRW of claim 17, wherein the first reinforcement sheet and the second reinforcement sheet include reinforcing fibers.

19. The SRW of claim 17, wherein the hollow-structure layer is laminated between a first skin layer and a second skin layer.

20. The SRW of claim 17, wherein the hollow-structure layer includes hollow cells configured to be filled with at least one filler material, which increases a stiffness of the hollow-structure layer.
